(19) United States
(12) Patent Application Publication
(10) Pub. No.: US 2010/0228625 A1
(43) Pub. Date: Sep. 9, 2010

(54) WIRELESS NETWORK USER TRACKING

(76) Inventors: Eswar Priyadarshan, West Roxbury, MA (US); Jayasurya Vadrevu, Lexington, MA (US); Ravikiran Chittari, Acton, MA (US); Dan Marius Grigorovici, Pleasanton, CA (US)

Correspondence Address: Apple Inc., 1000 Louisiana Street, Fifty-Third Floor, Houston, TX, 77002, US

(21) Appl. No.: 12/574,348

(22) Filed: Oct. 6, 2009

Related U.S. Application Data
(60) Provisional application No. 61/103,098, filed on Oct. 6, 2008.

(51) Int. Cl. G06Q 30/00; G06N 5/02; G06F 17/30

(52) U.S. Cl. 705/14.49; 706/54; 706/52; 707/737; 707/780; 707/E17.014; 707/E17.046

(57) ABSTRACT

Requests for WAP-enabled content from mobile subscribers may be assigned to a particular subscriber based on a degree of match between hashed request attribute groupings. Targeted contend and/or advertising may be directed at the subscribers based on identifying common requests assigned to the same subscriber.

### CROSS-REFERENCE TO RELATED APPLICATIONS

This application claims priority to and the benefits of U.S. provisional patent application Ser. No. 61/103,098, filed Oct. 6, 2008, the entire disclosure of which is incorporated herein by reference.

### FIELD OF INVENTION

The invention relates generally to systems and methods for tracking mobile network usage, and more specifically to determining user preferences and user behavior tendencies while accessing content from multiple wireless mobile networks and/or wired content domains using various access modalities.

### BACKGROUND

The use of mobile phones in the United States and around the world has increased dramatically. It is projected that soon the number of mobile phone users will exceed the number of fixed telephone subscribers. The proliferation of mobile phone usage has engendered corresponding advances in mobile phone technology. Mobile phones can now handle many types of multimedia content. Consumers can navigate the World Wide Web (the “Web”) from their mobile phones to much the same degree as from their home computers. Often, users switch between access devices, using a wireless device, a personal computer interchangeably throughout the day to access the same content. The proliferation of these new multimedia mobile phone devices and the implementation of wireless application protocols (WAP) have created a ripe market for the presentation of mobile-enabled content and advertising, which provides significant revenue opportunities for both third-party advertisers and wireless carrier companies. Some of the key challenges in providing targeted content and advertising to users are (i) to be able to accurately identify the user as often as possible, and (ii) to maintain comprehensive usage histories for individual users. The combination of these two capabilities leads to improved ad targeting and an enhanced user experience as users are provided with the content they want, when, where and on what device they want it.

While there have been many solutions with respect to traditional web usage (i.e., users browsing websites from a personal computer), no such solution provides the same depth and breadth of user profiling for mobile web usage, much less for identifying the same users as they alternate among delivery channels. While there are many differences, one key distinction is the added complexity of supporting multiple phone types, network types and carriers. For example, carrier-specific mobile identifiers such as x-up-subno and msisdn identify each subscriber with a unique user ID and pass it through request headers. However, the request header names vary from carrier to carrier, as some carriers may use phone numbers as the unique user ID, whereas others may use a randomly generated ID. Moreover, content providers (e.g., content distribution networks, advertising networks, etc.) cannot access a carrier's identifiers or headers when they are removed or scrambled from network data flows. This lack of information limits third-party mobile networks from providing a consistent experience to their users across different devices, carriers, and content formats.

In cases in which the mobile device supports the use of device-resident cookies, a network cookie identifier can be set. When a page request is serviced, a cookie is placed in the mobile browser. Such an approach does not work, however, for devices that do not accept cookies, or in cases in which the user disables such functionality. In implementations in which WAP gateways honor non-persistent cookies, session identifiers may be used to track session-specific usage, but such an approach does not provide a complete or persistent picture of a user's behavior over time.

What is needed, therefore, are techniques and supporting systems to track users and site visitors across multiple networks of mobile media properties as the users interact with the properties via mobile web, SMS, within mobile-device resident applications and conventional “wired” content sites.

### SUMMARY OF THE INVENTION

Various aspects of the invention facilitate the tracking and profiling of users of mobile devices and media. More specifically, the techniques described herein enable uniform user tracking across the major pillars of mobile media interaction—web, SMS, application usage and wired-to-mobile—using a network-resident cookie and hash matching. Such an approach implements user tracking via a “server-side cookie” that leverages device support for cookies (if available) but does not depend upon it. Such an approach also supports tracking for sites across multiple domains absent browser support for Javascript tags as well as cookies.

The network cookie enables advertiser targeting across multiple user sessions, content distribution channels, devices, and across different media interactions. Furthermore, data gathered over time enables the clustering of users having similar behavior patterns. Each of the mobile channels supplies unique data points to enable richer targeting and clustering based attributes of the content requests. As examples, mobile web sites identify content interests (based on the sites visited by a user), SMS supplies a phone number (from which we may derive a location), application supplies precise location (on platforms such as the iPhone). The user cookie/record is then augmented with these data points and uses the data for site personalization and targeting purposes.

To associate specific content requests to particular users and/or sessions, a hash_id is created as a unique user ID (UUID) for users in a locality-sensitive manner which optimizes the group containment logic of mobile users based on different attributes. The constituent attributes are spread across different dimensions (device type, model type, carrier, behavioral patterns, etc.) and thus captures various data points for each interaction. A probabilistic matching technique is then used to identify content requests that emanate from the same user (or device), to facilitate targeted advertising and content delivery.

Therefore, in a first aspect, a computer-implemented method for identifying and/or associating requests for WAP-enabled content with mobile subscribers includes receiving mobile content requests that include various request attributes and assigning each request attribute to attribute groups. A hash function is applied to each attribute group, and multiple mobile content requests are then assigned to a mobile subscriber based on a degree of match (which may be less than 100% in some cases) among corresponding hashed attribute groups.

The request attributes can be a device ID, a carrier ID, a telephone number, an account number, a MAC address, an IP address, a location, a SIM card ID, and/or a device model. The request attributes may be assigned to one group, no groups or in some cases more than one group. The groups may, in some cases, be unique across users. In some embodiments, a match confidence level is calculated that represents a degree of match between mobile content requests. In such cases, the match confidence level may be used to sort the mobile content requests, and some number (e.g., the top k requests where k is an integer) of the requests are assigned to a single mobile subscriber. The number of selected requests may be predetermined and/or based on a minimum confidence level threshold.

Once associated with a particular mobile subscriber, the content requests may be augmented with a user-specific identifier and stored in a database. The database of user-specific content requests may be used to identify subsequent requests as being associated with known subscribers. For example, subsequent mobile content requests may be received from an unidentified mobile subscriber. A query may be executed against the database to identify previously received mobile content requests that match, to some degree, the stored mobile content requests, such that the subsequent mobile content requests can be attributed to the same mobile subscriber as those in the query results. As such, the requested content may then be augmented with additional content (e.g., advertisements) consistent with the previously received mobile content requests, usage histories, and/or demographics.

In another aspect, a system for identifying and/or associating requests for WAP-enabled content with mobile subscribers includes a domain server and an ID processing module. The domain server is configured to receive mobile content requests that include various request attributes, such as a device ID, a carrier ID, a telephone number, an account number, a MAC address, an IP address, a location, a SIM card ID, and/or a device mode. The ID processing module is configured to assign each request attribute to an attribute group, apply a hash function to each attribute group, and assign mobile content requests to a mobile subscriber based on a degree of match among corresponding hashed attribute groups of the mobile content requests.

In some embodiments, the ID processing module assigns each of the request attributes to one group, whereas in other cases the attributes may be assigned to more than one group, or, in other cases, some attributes may be ignored and not used. The ID processing module may also calculate a match confidence level between mobile content requests based on the degree of match between corresponding hashed attribute groups. The resulting series of hashed groups may be sorted based on the match confidence level, and may be assigned a certain number of mobile content requests from the sorted mobile content requests to a single mobile subscriber. The number of assigned requests may be determined by confidence level threshold, for example.

The system may also include a database for storing the content requests, either as received, as processed by the ID processing module, and/or as augmented with a mobile subscriber ID. In such cases, the domain server may be further configured to receive subsequent mobile content requests from a mobile subscriber and query the database for previously received mobile content requests based on a degree of match among corresponding hashed attribute groups of the subsequent mobile content requests and the stored mobile content requests. The subsequent mobile content requests can then be assigned to the same mobile subscriber as those resulting from the query. Further content returned to the subscriber in response to the request may be augmented with advertisements consistent with the previously received mobile content requests, user preferences, and/or demographic information.

### BRIEF DESCRIPTION OF THE DRAWINGS

The foregoing and other objects, features, and advantages of the present invention, as well as the invention itself, will be more fully understood from the following description of various embodiments, when read together with the accompanying drawings, in which:

FIG. 1 schematically depicts a system and associated process flow for tracking mobile device usage in accordance with various embodiments of the invention.

FIG. 2 illustrates the bucket-based hashing process used to identify similar unique user identifiers in accordance with various embodiments of the invention.

### DESCRIPTION OF THE INVENTION

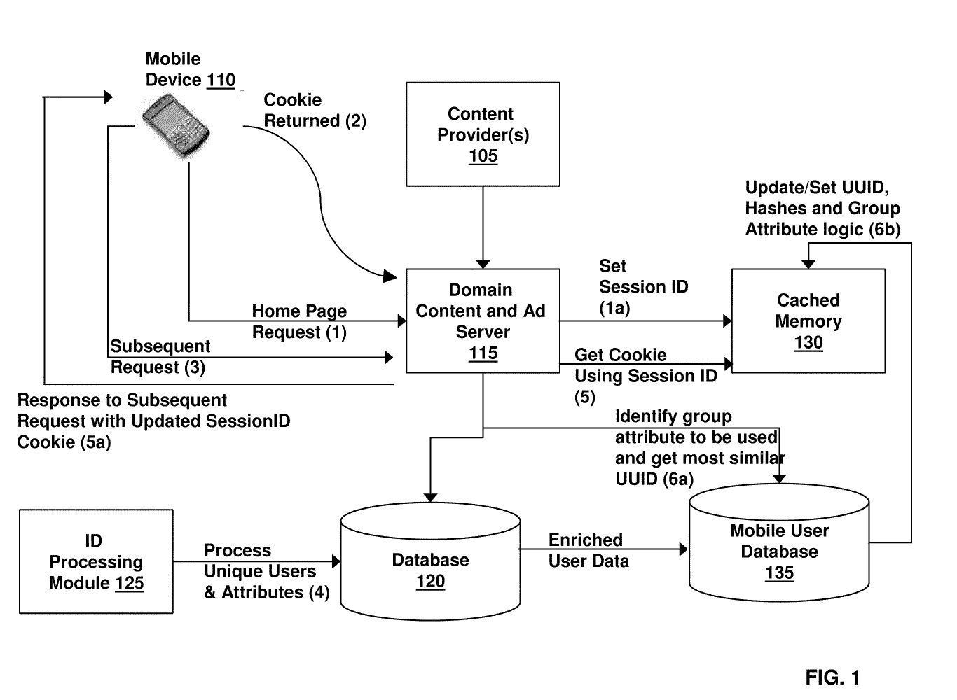

Referring to FIG. 1, content providers 105 create and provide content in the form of text, graphics, audio and video for presentation via the World-Wide Web (the “Web”). Often, the design, layout, and coding of the content is formatted for presentation on conventional Web browsers (e.g., Internet Explorer, Firefox, Chrome, etc.) operating on a personal computer. Such formatting often assumes certain size and aspect parameters that either conflict with or are not optimal for rendering on mobile devices 110 (e.g., PDAs, Blackberrys, smart phones, etc.). Moreover, the content providers often do not have the resources (in number, skill or sometimes both) to create and maintain an alternative branch of content specially formatted for presentation on mobile devices.

In response, many content providers have looked to ways to automatically process their existing web site source code into “mobile-specific” source code. Furthermore, the variety of devices and the likelihood that content varies among web pages and web sites means that certain pages (or even individual requests for certain pages) may be processed differently. To address this challenge, a domain content and ad server 115 (“domain server”) may be used to maintain “rule sets” that facilitate the generation of page-specific, site-specific, and/or device-specific source code. By doing so, web pages (and in some cases entire web sites) that are designed for full-screen display can be rendered on mobile devices without requiring manual design and development of a second, “mirror” site. Such functionality is described in greater detail in currently co-pending, co-owned U.S. patent application Ser. No. 12/138,876, entitled “Displaying Content on a Mobile Device,” the entire disclosure of which is incorporated by reference herein. Content specifically formatted and coded for presentation on wireless devices is commonly referred to as Wireless Application Protocol-enabled (“WAP-enabled” or “WAP”) content, and is transmitted using one or more “WAP” protocols.

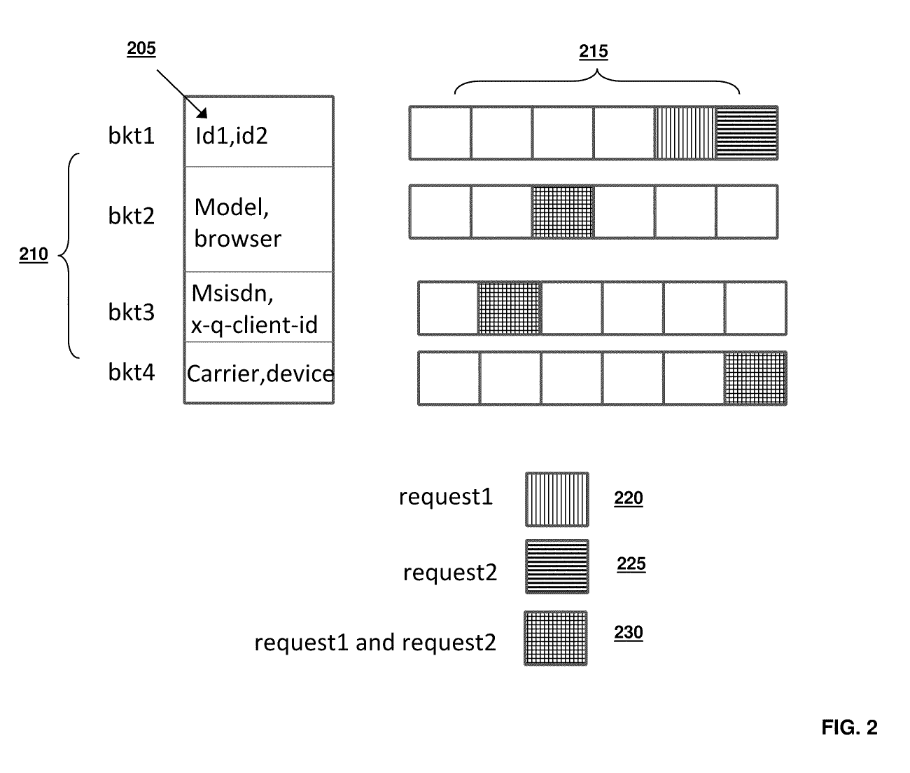

Still referring to FIG. 1, a request for content is sent from mobile device 110 to the domain server 115 and a server-side cookie is created on the domain server 115 that includes one or more attributes of the session. For example, the cookie may be created across multiple dimensions, some of which identify the user (via an account number or telephone number), the device (via a MAC address, model number, serial number or IP address), and/or the mobile network (via carrier ID). In one embodiment, for example, each page markup for a mobile-enabled website includes a cascading style sheet (“CSS”) request that triggers the domain-based cookie to be set on a mobile device (e.g., a cell phone, smart phone, personal data assistant, etc.). In some instances, groups of identifying characteristics are created and hashed, as described in greater detail below with reference to FIG. 2. In some cases, a session ID may also be used as an intermediate key to identify user interactions that occur during a common wireless session. In other cases, all of the identifying attributes may be missing or removed, and in such cases they may be generated and/or inferred based on recognition of behavioral patterns related to the request.

However, as the domain server 115 is used to create and serve WAP content (referred to herein as “content”) from multiple content providers, the need arises to be able to consistently identify and track individual wireless users and usage sessions. By doing so, content providers and advertisers can gain a more accurate profile of each user and/or groups of users in order to better target content and advertising. Therefore, in accordance with various embodiments of the invention, a unique user identifier (UUID) is created and used to track users as they browse, request and interact with content, applications and advertisements across multiple content and/or advertising domains (process 1). In one embodiment, the UUID is created and tracked using a server-side cookie (process 2) that contains various attributes of a mobile session and updated for subsequent requests (process 3). The UUIDs may be cached and/or stored in one or more databases 120 (process 1a) and processed by an ID processing module 125 (process 4) that groups, hashes, sorts and analyzes the UUIDs as described below. This “enriched” mobile user data may then be stored in a separate database 135, or, in some instances, a separate storage area (e.g., partition, table, set of tables, etc.) of the primary database 120. For subsequent requests with a matching sessionID, the cookie can be retrieved from the database (step 5) and returned to the device 110 (process 5a).

In some cases, a server-side cookie cannot be used due to device and carrier limitations. In other cases, as the server-side or session cookie is set, subsequent requests may not return the cookie information due to data flow loss, carrier scrambling processes, or users resetting the cookie persistence schedule on their devices. In addition, depending on the particular content channel, it may be difficult to match a cookie generated by one system (e.g., by an online content provider's servers) and automatically identify this as the same user as they request content on a different mobile device or network. In these cases, the domain server 115 queries the database 120 to determine whether a server-side cookie exists for the current request. If the cookie does not exist, the domain server 115 may query the mobile user database 135 for sets or subsets of attributes similar to the current request. Based on matching a relevant subset of group attributes and/or attribute combinations that are minimally needed to identify an unknown user, one or more matching users or user groups based on group attribute membership, or attribute pattern identification (process 6a). In some implementations, the ID processing module 125 is continuously updated the mobile user database 135 with the most recent, or new information about existing UUIDs as well as new, unknown users. Updates may be sent to a cached memory 130 in real time (process 6b) such that the most recent lists of UUID, hash and attribute groups and logic are available for incoming requests.

Any subsequent hits from the previously-visited mobile website domain gets the same cookie set on the domain server with the cookie swapping process occurring on the server-side via session ID as bridge. The cookie continues to propagate to other domains using the same process.

In implementations in which the content providers deliver content in real-time and that operate outside the domain server (e.g., a mobile site managed by a third-party publisher) the server-side cookie is propagated to the mobile users by inserting a 1×1 pixel image into advertisements and other content and sets the cookie for the domain-specific session. The session ID and/or client ID may used an intermediate key to assign the cookie for all the transactions. For short messaging service (“SMS”) feeds, a phone number or similar ID is transmitted along with the request for an ad to be delivered with an SMS feed. In other cases, the key may be a subscriber ID that is passed along with the click-through URL, which enables setting the server-cookie when users click on the link, and associates the SMS feed-specific ID with the server-side cookie ID.

For applications used via mobile devices (e.g., GMail for wireless, Facebook, etc.), the mobile applications provide an application-specific user ID when requesting an advertisement from the ad network. The user ID is concatenated to, embedded within, or otherwise made part of the click-through URL associated with the ad. When a user click on the ad, a browser is launched and communicates with the advertising server, enables the server-side cookie, and associates the application ID with the cookie ID. Adding a hosted “thank-you” page (or other jump-off page) is another way to set the server-side cookie for mobile devices using mobile applications.

FIG. 2 illustrates one embodiment of a “bucket-based” hashing technique for identifying, grouping and analyzing mobile requests. By grouping multiple requests based on users, carriers, devices and/or locations, content publishers and ad networks can use grouped requests to identify affinities and trends (e.g., iPhone users in Boston tend to purchase airline tickets on Thursdays, and prefer a particular airline) and target content and advertisements accordingly. Further, as the behavior of a specific group (a very granular subset of dimensions used in the UUID hash) is captured using these grouping techniques, clusters of similar behaviors can be generalized into behaviors of less granular groups. For example: if certain behaviors of all iPod users across the United States is derived based on large amounts of data, an overall average behavior (e.g., probability of selecting an ad or reading a particular piece of content) of all iPod users can be surmised. As a result, subsequent requests from iPod users can be processed (e.g., ads or content selected) based on the remaining partial information, absent the location identifier.

However, because not all of the particular attributes are available, and in some cases may actually change (a user may change carriers or devices, or have multiple devices) the technique for identifying requests to be grouped based on the UUIDs accounts for minor corrections, can operate with partial input (e.g., missing certain attributes) and can detect similar, but not necessarily identical UUIDs.

Again referring to FIG. 2, each mobile attribute 205 is placed into one or more buckets 210. In some instances, only one attribute may be in particular bucket, whereas in other cases there may be multiple attributes in a bucket. In some implementations, an attribute may be placed in more than one bucket. For each incoming request from a mobile device, a set of hash_ids 215 is then created for each bucket 210, and a hash collision probability is computed for each combination of requests. In one embodiment, the hash collision probability is a function of the number of matching attributes between the two requests. In such cases, as the number of matching buckets increases, the likelihood that the two requests came from the same user increases. As a result, as a new mobile request is received the system can quickly determine which previously-received UUIDs are likely matches and the confidence level of the match.

In some embodiments, each attribute is assigned a unique attribute ID, and the attribute IDs and respective hash values are stored as tuples or a list of ordered pairs of integers using a variable integer encoding technique. A distance function may then be used to determine the match probability by computing an XOR between each attribute hash value associated with matching attribute IDs and summing the “1s” in the resulting XOR'ed product vector.

For example, one approach uses four buckets {bkt1, bkt2, bkt3 and bkt4}. Bkt1 comprises attributes ID1 and ID2 (e.g., account number and telephone number), bkt2 comprises the device model number and browser, bkt3 comprises the MSISDN (SIM card number) and client ID, and bkt4 comprises the carrier (e.g., t-Mobile, Sprint, etc.) and the device (iPod, Blackberry, etc.). As request1 is received, the values in each attribute grouping are hashed, as represented by the vertically-shaded markers 220. As request 2 is received, the same hash function is applied. The resulting values are represented as the horizontally-shaded markers 225. For those that match, however, the overlapping patterns appear as cross-hatched markers 230. In the example shown, three of the four hashes match, resulting in a match confidence level of 0.75. This may occur in situations where, for example, a user switches account numbers and/or phone numbers, but uses the same device, browser and carrier.

More specifically, one method for identifying potentially matching UUIDs builds an ordered list of all UUIDs based on the number of matching buckets when compared to a candidate UUID using a distance calculation. The list is then sorted based on the calculated distance (e.g., closest UUID listed first) that represents the probability of a match. A number k of UUIDs may then be considered to be from the same user by selecting the top k UUIDs from the ranked list. The number k may be predefined number, a threshold (e.g., all UUIDs having a match confidence greater than 70%), or determined at run-time based on a time or processing limitation. The grouped UUIDs may then be “tagged” or otherwise annotated such that they are associated with the subscriber and her requests for mobile content.

The UUIDs may be stored in a database for reference and querying when subsequent mobile content requests are received from mobile subscribers. For example, if an unidentified subscriber sends a content request to the domain server, the ID processing module computer may process the request as described above and query the database for matching content requests in order to attribute the request to a previously identified subscriber. If the identified subscriber has known tendencies (based, for example, on previous content requests or request attributes) the requested content may be augmented with advertising or other content consistent with (or at least based on) known likes or attributes of the subscriber.

The processes described above may be implemented on the ID processing module 125 which may be operating on a computer which contains one or more processors on which commands and computational requests are processed. Memory, (either RAM, flash, ROM, or other storage means) stores computer-executable instructions for receiving and processing content requests, creating, storing and analyzing the hashed UUIDs, and performing the sorting and matching steps illustrated in FIG. 2 and described above. In some instances, the ID module 125 may be implemented on the same physical device as the domain server 115, either as a parallel process, or in its own virtual environment, whereas in other cases it may be a separate computational device.

In some embodiments, the processor and memory may implement the functionality of the present invention in hardware or software, or a combination of both on a general-purpose or special-purpose computer. In addition, such a program may set aside portions of a computers random access memory to provide control logic that affects one or more of the functions. In such an embodiment, the program may be written in any one of a number of high-level languages, such as FORTRAN, PASCAL, C, C++, C#, Java, Tcl, or BASIC. Further, the program can be written in a script, macro, or functionality embedded in commercially available software, such as EXCEL or VISUAL BASIC. Additionally, the software may be implemented in an assembly language directed to a microprocessor resident on a computer. For example, the software can be implemented in Intel 80×86 assembly language if it is configured to run on an IBM PC or PC clone. The software may be embedded on an article of manufacture including, but not limited to, computer-readable program means such as a floppy disk, a hard disk, an optical disk, a magnetic tape, a PROM, an EPROM, or CD-ROM.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A computer-implemented method for identifying associating requests for WAP-enabled content with mobile subscribers, the method comprising:
receiving a plurality of mobile content requests from a mobile device, each request comprising one or more request attributes;
assigning each request attribute to one or more attribute groups;
applying a hash function to each attribute group; and
assigning two or more mobile content requests to one mobile subscriber based on a degree of match among corresponding hashed attribute groups of the two or more mobile content requests.

2. The method of claim 1 wherein the request attributes comprise one or more of a device ID, a carrier ID, a telephone number, an account number, a MAC address, an IP address, a location, a SIM card ID, and a device model.

3. The method of claim 1 wherein at least one of the request attributes is assigned to more than one attribute group.

4. The method of claim 1 further comprising calculating a match confidence level for two or more mobile content requests based on the degree of match.

5. The method of claim 4 further comprising sorting the mobile content requests based on the match confidence level and assigning k mobile content requests from the sorted mobile content requests to a single mobile subscriber, wherein k is an integer.

6. The method of claim 5 wherein k is determined by a minimum confidence level threshold.

7. The method of claim 1 wherein the degree of match is less than 100%.

8. The method of claim 1 further comprising saving the two or more mobile content requests in a database.

9. The method of claim 8 further comprising:
receiving subsequent mobile content requests from a mobile subscriber;
querying the database for previously received mobile content requests based on a degree of match among corresponding hashed attribute groups of the subsequent mobile content requests and the stored mobile content requests;
assigning the subsequent mobile content requests to the same mobile subscriber as those resulting from the query; and
augmenting content returned in response to the subsequent mobile content requests with advertisements consistent with the previously received mobile content requests.

10. A system for identifying associating requests for WAP-enabled content with mobile subscribers, the system comprising:
a domain server for receiving a plurality of mobile content requests from a mobile device, each request comprising one or more request attributes;
an ID processing module configured to:
assign each request attribute to one or more attribute groups;
apply a hash function to each attribute group; and
assign two or more mobile content requests to one mobile subscriber based on a degree of match among corresponding hashed attribute groups of the two or more mobile content requests.

11. The system of claim 10 wherein the request attributes comprise one or more of a device ID, a carrier ID, a telephone number, an account number, a MAC address, an IP address, a location, a SIM card ID, and a device model.

12. The system of claim 10 wherein the ID processing module is further configured to assign at least one of the request attributes to more than one attribute group.

13. The system of claim 10 wherein the ID processing module is further configured to calculate a match confidence level for two or more mobile content requests based on the degree of match.

14. The system of claim 13 wherein the ID processing module is further configured to sort the mobile content requests based on the match confidence level and attribute k mobile content requests from the sorted mobile content requests to a single mobile subscriber, wherein k is an integer and determined by a minimum confidence level threshold.

15. The system of claim 14 further comprising a database for storing the two or more mobile content requests as associated with the mobile subscriber.

16. The system of claim 15 wherein the domain server is further configured to:
receive subsequent mobile content requests from a mobile subscriber;
query the database for previously received mobile content requests based on a degree of match among corresponding hashed attribute groups of the subsequent mobile content requests and the stored mobile content requests;
assign the subsequent mobile content requests to the same mobile subscriber as those resulting from the query; and
augment content returned in response to the subsequent mobile content requests with advertisements consistent with the previously received mobile content requests.
